(19) United States
(12) Patent Application Publication
(10) Pub. No.: US 2010/0008583 A1
(43) Pub. Date: Jan. 14, 2010

(54) APPARATUS, SYSTEM, AND METHOD FOR IDENTIFYING VISUAL STRUCTURES

(75) Inventor: Christopher James Winstead, Logan, UT (US)

Correspondence Address: UTAH STATE UNIVERSITY;TECHNOLOGY COMMERCIALIZATION OFFICE, 570 RESEARCH PARK WAY, SUITE 101, NORTH LOGAN, UT, 84341, US

(73) Assignee: UTAH STATE UNIVERSITY, North Logan, UT (US)

(21) Appl. No.: 12/499,639

(22) Filed: Jul. 8, 2009

Related U.S. Application Data
(60) Provisional application No. 61/078,821, filed on Jul. 8, 2008.

(51) Int. Cl. G06K 9/18; G06K 9/46

(52) U.S. Cl. 382/185; 382/190

(57) ABSTRACT

A “gliding” interface operates in a space of visual perceptions and tries to predict an intended pattern sequence to enable a high-speed recognition of Asian writing with a simple interface. When a search begins, the user is presented with a collection of visual patterns within a box. The user can “zoom in” on a visual pattern by moving the cursor toward it. As the user zooms closer, a new layer of patterns appears within the box. The new layer includes more complex visual patterns than those in the previous layer. The system is mistake-tolerant, with no single cumulation of visual patterns required to achieve a specific visual pattern; rather, a statistical algorithm selects the visual patterns most likely to match the unknown structure. The algorithm is updated as the user searches, tracking every visual pattern that the user traverses while using the interface. A database contains groups of visual patterns that describe each Kanji character. The tracked visual patterns are correlated against the database to determine the visual patterns with the most visual similarity. The visual patterns with the highest correlation are displayed in the new layer.

### RELATED APPLICATIONS

This application claims priority to U.S. Provisional Application No. 61/078,821 filed on Jul. 8, 2008, entitled “APPARATUS, SYSTEM, AND METHOD FOR IDENTIFYING VISUAL STRUCTURES” and is incorporated herein by reference.

### FIELD OF THE INVENTION

This invention relates to a method for identifying structures based on visual appearance and more particularly relates to the identification of Kanji structures using a computer interface to find visual elements that appear within the structures.

### BACKGROUND OF THE INVENTION

60% of all characters that appear in typical Japanese text are written in Kanji. Therefore, an understanding of the Japanese language requires a working knowledge of Kanji which may take 3 to 5 years to obtain. Current language reference tools, such as Kanji dictionaries, require considerable knowledge to be used effectively, sometimes taking months of study to understand. Furthermore, even more experienced students make mistakes easily, forcing searches to be repeated.

The proposed invention enables users at all knowledge levels, even novice users, a high-speed recognition of Asian writing with a simple interface. The interface uses a “gliding” interface similar to David MacKay's accessibility interface called “Dasher,” but instead of using an alphabetical space it operates in a space of visual perceptions and tries to predict an intended pattern sequence. When a search begins, the user is presented with a collection of visual patterns within a box. The user can “zoom in” on a visual pattern by moving the cursor toward it. As the user zooms closer, a new layer of patterns appears within the box. The new layer includes more complex visual patterns than those in the previous layer. Descriptions therefore evolve, beginning with simple morphology and advancing into exact patterns. Once the unknown structure is found, the interface includes a dictionary that provides the words, pronunciations, and definitions associated with the structure. The proposed invention has an advantage over the current art because it is mistake-tolerant, with no single cumulation of visual patterns required to achieve a specific visual pattern; rather, a statistical algorithm “guesses” the visual patterns most likely to match the unknown structure. The algorithm is updated as the user searches, tracking every visual pattern that the user traverses while using the interface. A database contains groups of visual patterns that describe each Kanji character. The tracked visual patterns are correlated against the database to determine the visual patterns with the most visual similarity. The visual patterns with the highest correlation are displayed in the new layer.

The proposed invention also applies to other languages, such as Chinese and Korean. Furthermore, the invention encompasses the identification of animals, insects, plants, and is not limited by 2-dimensions or 3-dimensions.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic flow chart illustrating one embodiment of a method to identify structures in accordance with the present invention:

FIG. 2 is a diagram illustrating a possible embodiment of an unknown structure that is identified through the present invention;

FIG. 3 is a schematic flow chart illustrating one embodiment of a method to identify visual structures in accordance with the present invention;

Figure FIG. 4 is a schematic flow chart illustrating one embodiment of a method to display visual patterns and known structures based on a count of weight in accordance with the present invention;

FIG. 5 is a schematic flow chart illustrating one embodiment of a method to assign weights to a visual pattern;

FIG. 6 is a diagram illustrating one embodiment of a visual depiction of a count given to exemplary weights given to a grouping of visual elements and visual patterns to retrieve a visual pattern.

FIG. 7 is a schematic flow chart illustrating one embodiment of a method to navigate through more than one visual pattern to identify visual structures in accordance with the present invention.

FIG. 8 is a schematic flow chart illustrating one embodiment of a method to navigate through the interface to display the visual pattern.

FIG. 9 is a schematic block diagram Illustrating one embodiment of a structure identification apparatus of the present invention,

### DETAILED DESCRIPTION OF THE INVENTION

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different, storage devices, and may exist, at least partially, merely as electronic signals on a system or network. Where a module or portions of a module are implemented in software, the software portions are stored on one or more computer readable media.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Reference to a signal bearing medium may take any form capable of generating a signal, causing a signal to be generated, or causing execution of a program of machine-readable instructions on a digital processing apparatus. A signal bearing medium may be embodied by a transmission line, a compact disk, digital-video disk, a magnetic tape, a Bernoulli drive, a magnetic disk, a punch card, flash memory, integrated circuits, or other digital processing apparatus memory device.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

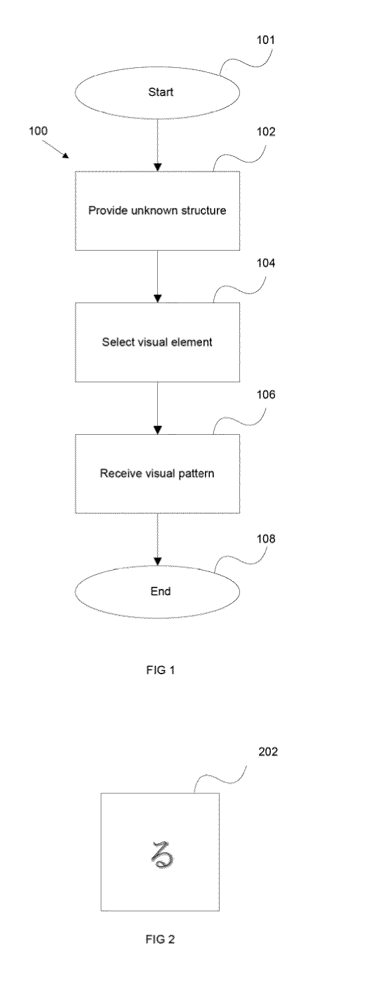

FIG. 1 is a schematic flow chart illustrating one embodiment of a method 100 to identify structures in accordance with the present invention. The method 100 starts 101 when the unknown structure is provided to the user 102. In one embodiment, the user is provided the unknown structure 102 on the interface. In another embodiment, the user is provided the unknown structure 102 from a source other than the interface, such as a photograph, visual representation, or physical presence. The 102 unknown structure may take the form of a character from the Japanese alphabet, or may be a structure from another language. In one embodiment, the structure may be an animal, insect, plant, or object. In one embodiment, the unknown structure 102 has 2, 3, or more dimensions.

Next, the method 100 selects a visual element 104. Alter selecting the visual element 104, the user receives a visual pattern 106. In one embodiment of the invention, the sequence of selecting the visual element 104 and receiving the visual pattern 106 occurs more than one time. Each visual pattern 106 received contains a similar feature or the same feature as contained in one or more of the selected visual elements 104. The feature may also be or include one or more of the visual elements 104. When the final visual pattern 106 received satisfactorily resembles the unknown structure to the user, the method ends 108. The level of satisfaction may depend on a variety of factors or combination of factors, including but not limited to, a level of similarity determined by the identification system, such as scanning the unknown structure and comparing it to the visual pattern. The level of satisfaction may also rest on the user's own judgment in comparing the visual pattern to the unknown structure. FIG. 2 is a visual representation of an exemplary unknown structure 202, namely, a Kanji character used in the Japanese language.

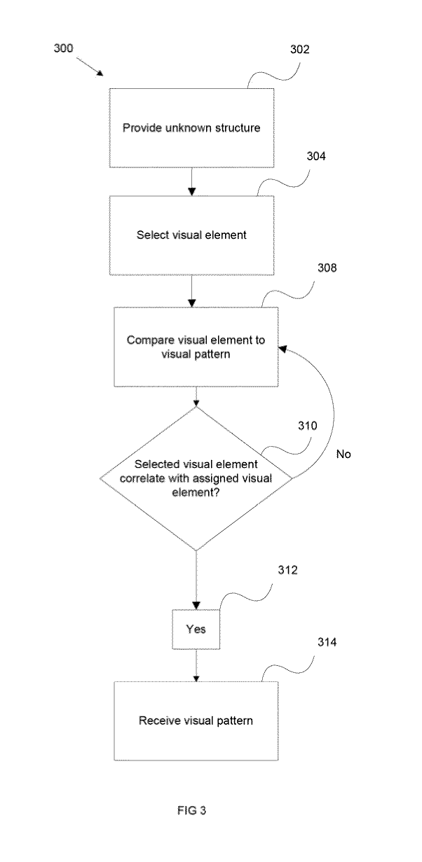

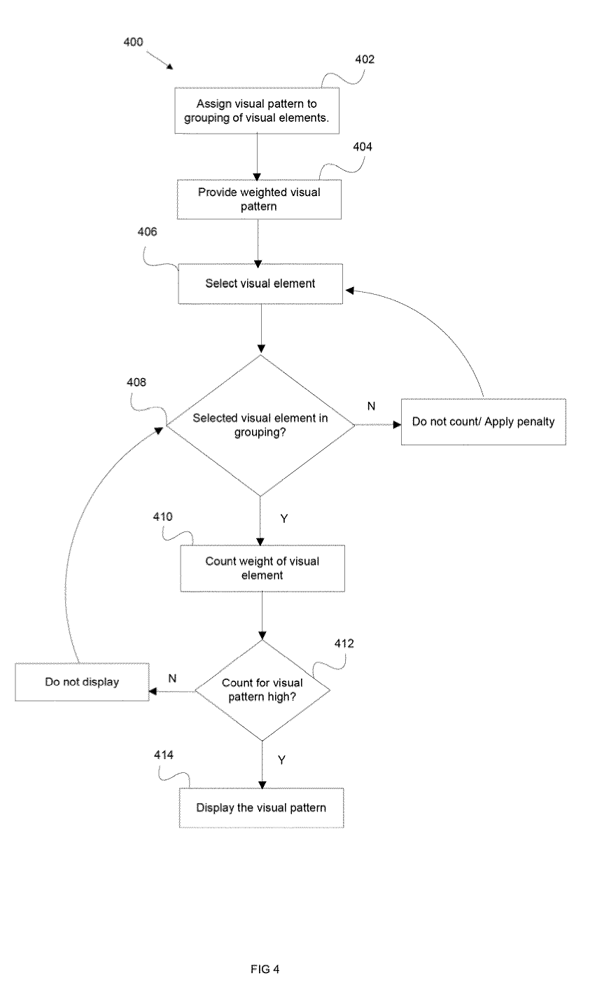

FIG. 3 is a schematic flow chart illustrating one embodiment of a method 300 to identify structures in accordance with the present invention. The method 300 includes the aforementioned steps in providing the unknown structure 302, selecting the visual element 304, and receiving the visual pattern 306. The selected visual element 304 is compared to a visual element that is assigned or featured in a visual pattern 308. If the visual pattern 308 contains or sufficiently contains the visual element 304, it is received by the user in step 314. If the visual pattern does not contain or sufficiently contain the visual element 304, the visual pattern will be compared to another visual, pattern.

FIG. 4 is a schematic flow chart illustrating one embodiment of a method 400 to display the visual pattern 414. The method 400 assigns a particular visual pattern to a group of visual elements 402 that have been weighted. The user receives the visual pattern 404 that has been weighted relative to other visual patterns. The user selects the visual element 406 from the weighted visual pattern. The comparison module compares the selected element to the grouping assigned to a visual pattern 408. If the visual element is included within the grouping, the weight of the selected visual element is recorded and counted 410 in the statistical module. Otherwise, no count occurs. Alternatively, the system may apply a negative count if the visual element is not contained within the grouping. A negative count or applying an alternative weight is used to lessen the chance that the grouping will be selected to be displayed. After a series of visual elements has been recorded, the count is completed. If the count for a visual pattern is high 412, the system will display the visual pattern 414. If not, the visual pattern will, not be displayed.

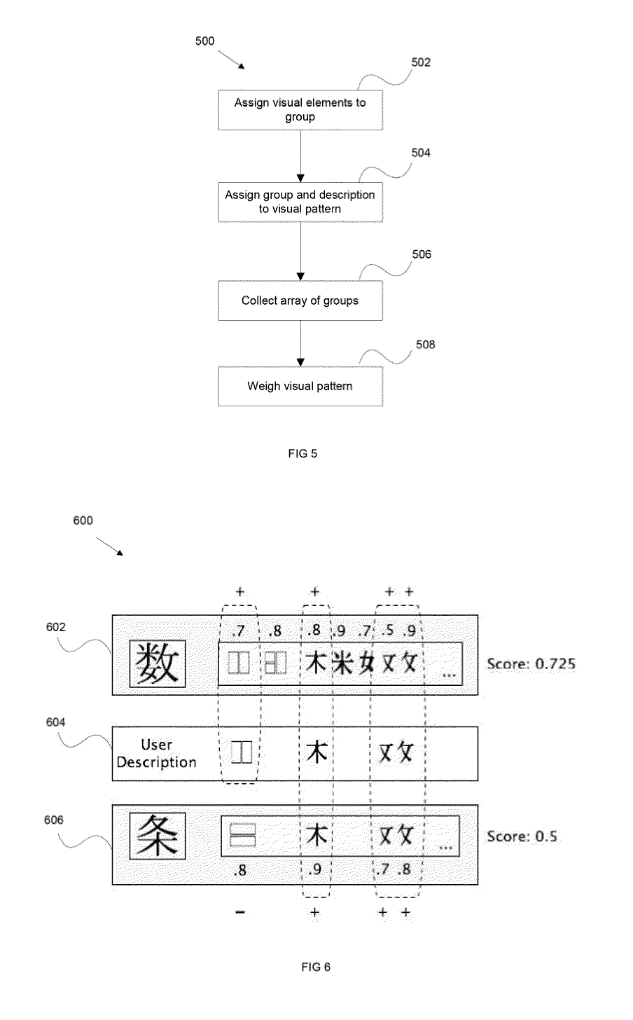

FIG. 5 is a schematic flow chart illustrating one embodiment of a method 500 to weight visual patterns. The user selects a group of visual patterns 502 preferred in making up a particular visual pattern 504. Another user or the same user selects another group of visual patterns 502 to properly make up a particular visual pattern 504. The system collects the array of groups and assigns them to a visual pattern 504. The system also assigns a description to the visual pattern 504. In one embodiment of the invention, each visual pattern 502 that has been assigned to the group that is assigned to a visual pattern receives the weight. This weight may be designated according to the rate at which it has been assigned to the group, such as a number that is proportional to the number of times it has been assigned to the group.

FIG. 6 is a screenshot that exemplifies a possible means to compare the group of visual elements selected by the user, labeled User Description 604, with the group of visual elements that are assigned to the visual pattern 602. As the user selects the visual element, it is stored in a redaction module as shown in FIG. 9. Each additional visual element is added to the redaction module. Once a sequence containing one or more visual elements is completed, the comparison module 1014 compares the group of visual elements against other groups that have been assigned to the visual pattern. In one embodiment of the invention, the groups contain visual elements that have weights attached to each visual pattern. This weight may be associated with the frequency with which the visual element is used in conjunction with the visual pattern. The comparison module 1014 ranks, counts, or performs a function that will select the group of visual elements assigned to the visual pattern that most highly corresponds to the group of visual elements that were selected by the user. In one embodiment of the invention, the comparison module 1014 counts the weight of the visual element in a grouping 602 when it matches the visual element selected by the user. In another embodiment of the invention, the comparison module 1014 subtracts the weight of the visual element in the grouping 606 if it does not match the visual element selected by the user.

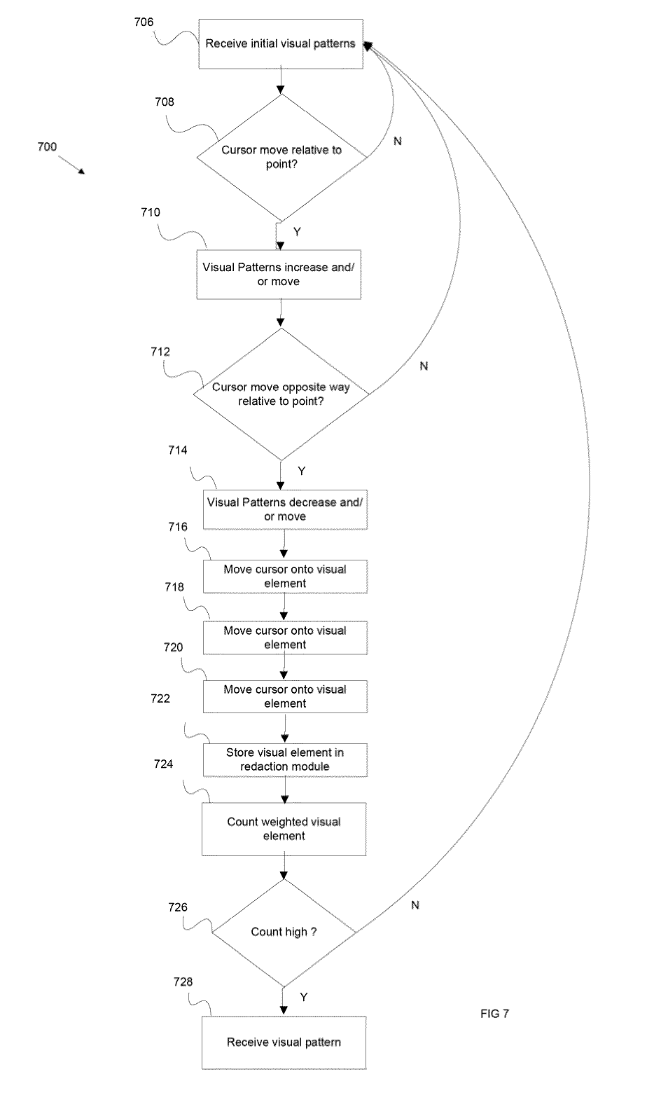

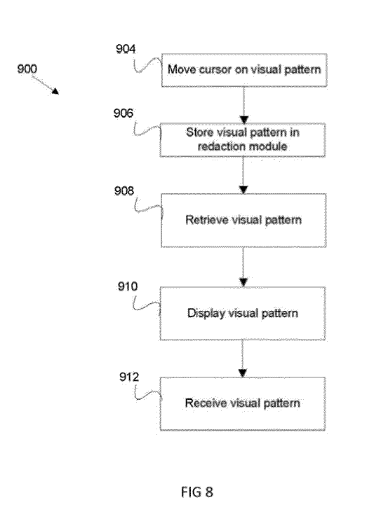

FIG. 7 is a schematic flow chart illustrating one embodiment of a method to navigate through an interface and receive a visual pattern. The user receives the initial visual pattern or visual patterns 706. By moving a mouse or another mechanism, the user can move the cursor relative a point 708. If the cursor is moved in a certain direction 708, such as to the right of the point and toward the visual patterns, the visual patterns increase. If the cursor is moved in the opposite direction 714, such as to the left of the point and away from the visual patterns, the visual patterns decrease. Other movements or change in visual appearance may occur in response to the movement of the cursor. If the cursor moves to a predefined distance away from the predefined point, the user will receive the previous display of initial visual patterns. Alternatively or additionally, the previous display will occur when the visual patterns change to a certain degree. On the other hand, if the cursor moves to the predefined distance away from the point, or if the cursor is moved to rest on the visual pattern, the redaction module 1006 will store the visual element. The comparison module 1014 counts 720 the weight of the visual element as it relates to a visual pattern. If the cursor has moved on to previous visual patterns, the weights of the previously selected visual elements are also added to the count as they relate to each visual pattern. Thus, a count 720 is made for all visual patterns. The visual element will have a different weight assigned to each visual pattern, the weight associated to the frequency or probability in which it is used in connection with a visual pattern. If the comparison module 1014 finds the count 720 for a visual pattern is high 722 or if the count exceeds a threshold in relation to the other visual patterns, the user will receive the visual pattern 724.

In one embodiment of a user interface a main window provides the cursor with space available to move the cursor within a boundary. The patterns appear on the right of the window. In response to the user via the cursor or other mechanism, the patterns change in appearance, such as indicated by size, position, and movement. The match list provides the display of visual patterns to the user. A description appears when the visual element selected by the user matches the visual pattern found by the comparison module. The Description indicates the visual elements that are recorded by the redaction module as the visual elements that have been selected by the user. These displays of visual elements are also the visual elements that will be used to compare with the groupings assigned to visual patterns.

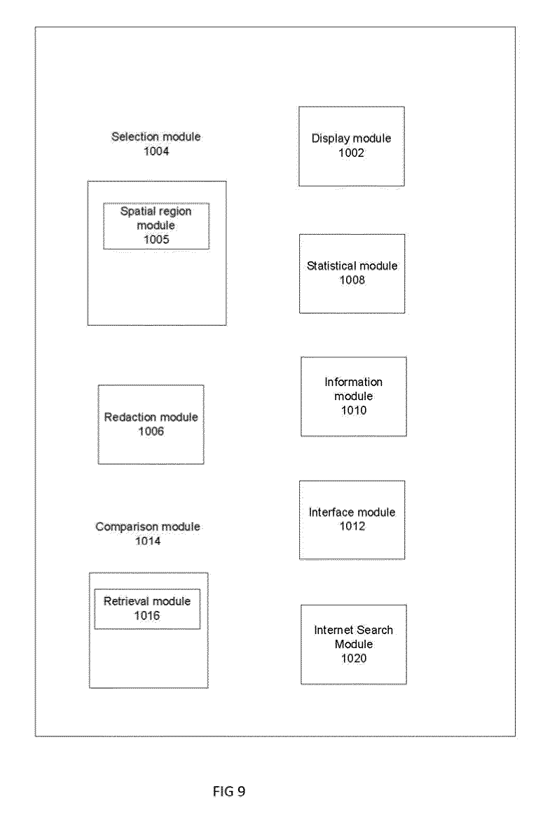

FIG. 8 is a schematic flow chart illustrating one embodiment of a method 900 to display the visual pattern as part of the navigation of the interface. The user moves the cursor on to the visual pattern or visual element. The comparison module 1014 retrieves the visual pattern 908 associated with the visual pattern or visual element. The display module 1002 displays the visual pattern 910. Multiple visual patterns may be assigned to the visual pattern. The assignments may not be associated with a weight, but they may be predefined in such a way that certain visual patterns cause the comparison module 1014 to retrieve certain visual patterns. The visual patterns that the cursor moves on may be saved in the redaction module 1006 and be used as part of the groups of visual patterns to retrieve a visual pattern and displayed to the user. When the user moves the cursor away from visual pattern and returns to the previous visual pattern, the visual pattern may be removed from the redaction module 1006. Additionally, the visual pattern, may be changed in appearance, such as by color, to indicate that the cursor has navigated to the visual pattern. When the cursor clicks on the visual pattern or the user performs another function, the visual pattern has been selected and will appear in the description box. This visual pattern will be used to determine the next set of visual patterns that appear. The visual patterns that have been navigated through to arrive at the selected visual pattern may or may not appear in the description box.

FIG. 9 is a schematic flow chart illustrating one embodiment of a computer program product 1000 for the identification of an unknown structure. The computer program product includes a display module 1002, a selection module 1004, a redaction module 1006, a statistical module 1008, an information module 1010, an interface module 1012, an internet search module 1020, and a comparison module 1014. The Comparison module 1014 includes a retrieval module 1016. The Selection module 1004 includes a spatial region module 1005,

The display module 1002 displays images on the screen, the screen being a medium such as a computer screen, television screen, hand-held device containing a screen (such as PDA, cell phone, or electronic dictionary), or another medium in which visual appearance can be manifested. The display module 1002 displays a visual pattern, or a plurality of visual patterns, from which the user may select a visual element. The display module 1002 also displays the cursor and each visual element that is selected by the user. The display module 1002 may further display the visual patterns that have been navigated through by the cursor and which are stored by the redaction module 1006. The display module 1002 may also display the weighting or calculations associated with the visual patterns and the visual patterns that the user moves the cursor on, among other visual depictions that represent or that give rise to interpretation regarding the steps of the method in identifying a structure.

The selection module 1004 is responsible for selecting the visual element from the visual pattern displayed by the display module 1002 or from the plurality of visual patterns displayed by the display module 1002. The selection module 1004 may include a spatial region module 1005 that selects a spatial region of the visual pattern or unknown structure to be the visual element. In one embodiment of the invention, the unknown structure is given to the selection module 1004. This could take the form of a picture being scanned into a computer and the selection module 1004 scanning the picture and selecting one more regions of the picture to be the visual element,

The redaction module 1006 stores the visual element selected by the selection module 1004. Additionally, the redaction module 1006 stores a record of the visual pattern that the user moves the cursor on as the user navigates through visual patterns. The redaction module 1006 may remove the record of tire visual pattern when, the user moves the cursor to a predefined distance away from a particular point. The redaction module 1006 may be triggered to remove the record when the visual patterns change in appearance to a certain degree. The redaction module 1006 may also be triggered to remove the record of the visual pattern when the user navigates away from the visual pattern, returning to the prior display of visual patterns.

The statistical module 1008 weights the visual element or visual pattern based on the frequency of selecting the visual element or visual pattern in relation to the grouping of visual patterns that describe a particular visual pattern. The statistical module 1008 may weigh the visual pattern based on the frequency with which it is navigated through by the cursor. The statistical module 1008 may also weight the visual pattern based on the order of selection of visual patterns by a user.

The information module 1010 stores information related to the visual pattern, such as the word definition of a Kanji character. The information module 1010 may also include information such as the root, origin, pronunciation, or etymology of the visual pattern. In other uses, such as the identification of birds, the information may comprise a description of the birds consumption habits, common places of dwelling, and migratory patterns. The information need not be in the form of text, but rather, may include images, web links to other sites, or other relevant information pertaining to the selected visual patterns.

The interface module 1012 navigates through groupings of visual patterns on the display module. The user moves the position of the cursor as it is displayed by the display module 1002 relative to a particular point and visual pattern change in appearance or position in response to the movement. Once the cursor is placed on the visual pattern, the interface module causes the display module 1002 to display the next visual pattern or plurality of visual patterns assigned to the visual pattern. The next visual pattern or plurality of visual patterns to be displayed may also be determined by the statistical module 1008 according to the weighting of the visual pattern or an accumulation of weighting from a group of previously selected visual patterns. In addition to navigating through visual patterns, the statistical module 1008 also retracts through visual patients. As the user moves the cursor away from a particular point, or the visual patterns change appearance to a certain degree, the interface module 1010 prompts the display module 1002 to display the previous visual pattern or plurality of visual patterns.

The internet search module 1020 provides a link to an internet search engine on the display module 1002. The internet search module 1020 may pass information related to the visual pattern to the Internet search engine to create a real-time interactive environment for the user.

The comparison module 1014 compares the selected visual element to each visual element in the redaction module 1006 to determine a visual pattern comprising a visual element substantially similar to the selected visual element. The comparison module 1014 may rely on the information in the statistical module 1008 to compare weights between visual elements or visual patterns. The retrieval module 1016 retrieves the visual pattern that most strongly correlates to the visual element or series of visual elements that have been selected. In a further embodiment of the invention the comparison module 1014 also compares the visual patterns that have been navigated through by the user in arriving at the selected visual element.

What is claimed is:

1. A method for identifying structures, the method comprising:
providing an unknown structure;
storing a plurality of first visual patterns;
storing a plurality of second visual patterns;
indentifying a first visual element appearing in the unknown structure;
selecting a first visual pattern associated with said first visual element from said stored plurality of first visual patterns;
indentifying a second visual element appearing in the unknown structure;
selecting a second visual pattern associated with said second visual element from said stored plurality of second visual patterns;
identifying a final structure associated with said first and second visual patterns.

2. The method of claim 1, further comprising storing said plurality of first visual patterns that include a weighting of each visual pattern.

3. The method of claim 2, further comprising selecting said first visual pattern from said plurality of first visual patterns according to the weight of said first visual pattern wherein the weighting of each said first visual pattern of said plurality of first visual patterns is based on the frequency of selection of said each first visual pattern.

4. The method of claim 2, wherein each said first visual pattern is assigned a grouping of visual patterns and given a score based on a comparison of the visual patterns in the grouping to the visual patterns selected by the user.

5. The method of claim 2, wherein each known structure is assigned a grouping of visual patterns and given a score based on a comparison of the visual patterns in the grouping to the visual patterns selected by the user.

6. The method of claim 4, wherein said score is used to determine the visual pattern or known structure to be displayed and to determine the order in which each visual pattern or known structure is displayed.

7. A computer program product comprising:
a computer readable storage medium having computer usable program code executable to perform operations for identifying an unknown structure, the computer program product comprising:
a display module that displays a plurality of visual patterns;
a selection module that selects a first visual element from the plurality of visual patterns; and
a retrieval module that retrieves a first visual pattern that contains a visual element that is substantially similar to the selected first visual element.

8. The computer program product of claim 7, further comprising a structure module that provides a structure to the computer program product.

9. The computer program product of claim 7 wherein the selection module comprises a spatial region module that selects a spatial region of the visual pattern or structure as the visual element.

10. The computer program product of claim 7 wherein the retrieval module retrieves a second visual pattern after the selection module selects a second visual element.

11. The computer program product of claim 7, further comprising a statistical module that weights the visual pattern or patterns based on the frequency of selection of each visual pattern of the plurality of visual patterns or based on the order of selection of the visual patterns by a user.

12. The computer program product of claim 11, wherein said retrieval module retrieves the visual pattern based on the weight of each visual pattern.

13. The computer program product of claim 7, further comprising an information module that stores information related to the first visual pattern, wherein the information comprises at least one member of a group comprised of at least one name for the first visual pattern, at least one name for a larger entity of which the first visual pattern belongs, at least one name for a plurality of larger entities of which the first visual pattern belongs.

14. The computer program product of claim 7, further comprising an interface module that navigates through groupings of visual patterns on the display module by moving the position of a cursor relative to a center point, a visual pattern from a plurality visual patterns becoming larger as the cursor moves closer to the center point up to a predefined point, the cursor positioned at the predefined point prompting the display module to display another plurality of visual patterns related to the selected visual element.

15. The computer program product of claim 14, wherein the interface module causes the display module to change the appearance of a visual pattern once a user has navigated to the visual pattern.

16. The computer program product of claim 7, further comprising:
a redaction module that retains a record of each visual pattern enlarged to the particular point; and
a redaction module that removes the record of each visual pattern related to the particular point when the corresponding visual pattern is later reduced to a smaller size.

17. The computer program product of claim 7, wherein the comparison module compares the selected visual element to each visual element in the redaction module to determine a visual pattern comprising a visual element substantially similar to the selected visual element.

18. The computer program product of claim 7, further comprising an internet search module that provides a link to an internet search engine and passes information related to the visual pattern to the internet search engine.

19. The computer program product of claim 7, wherein each visual pattern is an ideographic character, such as one comprising one member of the group comprising a Japanese Kanji and a Chinese Kanji.

20. A system to identify an unknown structure, the system comprising:
a display;
a database comprising;
weighting of each visual element, which correlates to the frequency of selection of the visual element;
a plurality of units containing information related to a visual pattern; and
a computer with computer readable storage memory and a processor that store and execute;
a display module that displays a plurality of visual patterns on the display;
an interface module that allows navigation through groupings of visual patterns on the display module by moving the position of a cursor relative to a center point, a visual pattern from a plurality visual patterns becoming larger as the cursor moves closer to the center point up to a predefined point, the cursor positioned at the predefined point prompting the display module to display another plurality of visual patterns related to the selected visual element;
a selection retention module that retains a record of each visual pattern enlarged to the particular point;
a redaction module that removes the record of each visual pattern enlarged to the particular point when the corresponding visual pattern is later reduced to a size smaller than the particular point;
a comparison module that compares the selected visual element to each visual element in the retention module to determine a visual pattern comprising visual elements substantially similar to the selected visual element; and
an information module that displays information related to the particular visual pattern from a unit of information associated with the particular visual pattern in the database.

21. The system of claim 20, wherein said display, said database, and said computer are all housed in a single handheld device.
